(19) United States
(12) Patent Application Publication
(10) Pub. No.: US 2020/0169880 A1
(43) Pub. Date: May 28, 2020

(54) NETWORK SERVICE SYSTEM AND NETWORK SERVICE METHOD

(71) Applicant: Industrial Technology Research Institute, Hsinchu (TW)

(72) Inventors: Kuo-Wei WEN, Taoyuan City (TW); Jian-Cheng CHEN, Taoyuan City (TW); Jian-Hao CHEN, Kaohsiung City (TW)

(21) Appl. No.: 16/232,565

(22) Filed: Dec. 26, 2018

(30) Foreign Application Priority Data
Nov. 23, 2018 (TW) 107141785

(51) Int. Cl. H04W 12/06; H04W 4/50; H04L 29/06

(52) U.S. Cl. CPC H04W 12/06; H04L 63/102; H04W 4/50

(57) ABSTRACT

The network service system includes a transmission controller and an authentication server. The transmission controller determines whether a service request belongs to a service of a proprietary network registered with the mobile edge computing platform and comprises an authentication request. The service request is from an electronic device. When the transmission controller determines that the service request belongs to a service of the proprietary network and comprises an authentication request, the authentication server executes an authentication mechanism according to packet information that corresponds to the service request, and the authentication mechanism triggers a permission server to confirm the identity information and permission information of the electronic device.

### CROSS REFERENCE TO RELATED APPLICATIONS

This application claims priority of Taiwan patent application no. 107141785, filed on Nov. 23, 2018, the entirety of which is incorporated by reference herein.

### TECHNICAL FIELD

The present disclosure relates to a network service system and a network service method, and in particular it relates to a network service system and a network service method suitable for use with a mobile edge computing platform.

### BACKGROUND

Mobile edge computing provides information transfer and cloud computing capabilities to mobile users of a radio access network. Mobile edge computing provides application developers with a low-latency and high-capacity service environment, and mobile edge computing can process or divert data streams that were originally required by the core network at the local end.

However, the operating mechanism of existing mobile edge computing platforms is bypassed at the service destination accessed by the user device, but the identity of the user device may not be recognized. For example, when the mobile edge computing constructed by both the enterprise and the network operator wants to perform an offloading service for the enterprise user device, the existing mobile edge computing platform cannot perform packet control on the user device having the enterprise identity.

Therefore, how to provide a method for recognizing the identity of a user device in a network packet to satisfy the action edge operation to perform a traffic distribution mechanism for a user device with a specific identity has become one of the challenges to be solved in the field.

### SUMMARY

In accordance with one feature of the present invention, the present disclosure provides a network service system. The network service system is suitable for use in a mobile edge computing platform. The network service system comprises a transmission controller and an authentication server. The transmission controller determines whether a service request belongs to a service of a proprietary network registered with the mobile edge computing platform and comprises an authentication request. The service request is from an electronic device. When the transmission controller determines that the service request belongs to the service of the proprietary network and comprises the authentication request, the authentication server executes an authentication mechanism according to a packet information that corresponds to the service request, the authentication mechanism triggers a permission server to confirm an identity information and a permission information of the electronic device.

In accordance with one feature of the present invention, the present disclosure provides a network service method. The network service method is suitable for use in a mobile edge computing platform. The network service method comprises: determining whether a service request belongs to a service of a proprietary network registered with the mobile edge computing platform and comprises an authentication request, and when determining that the service request belongs to the service of the proprietary network and comprises the authentication request, executing an authentication mechanism according to a packet information that corresponds to the service request, the authentication mechanism triggers a permission server to confirm an identity information and a permission information of an electronic device. The service request is from the electronic device.

### BRIEF DESCRIPTION OF THE DRAWINGS

FIG. 1 is a block diagram of a network service system in accordance with one embodiment of the present disclosure.

FIG. 2 is a schematic diagram of a network service system in accordance with one embodiment of the present disclosure.

FIG. 3 is a schematic diagram of an application uploading method of a network service system in accordance with one embodiment of the present disclosure.

FIG. 4 is a block diagram of a mobile edge computing system MEC in accordance with one embodiment of the present disclosure.

FIG. 5 is a schematic diagram of an uploading application method used by the network service system in accordance with one embodiment of the present disclosure.

FIG. 6 is a schematic diagram of an identity authentication method of the electronic device by the network service system in accordance with one embodiment of the present disclosure.

FIG. 7 is a schematic diagram of a remote authentication method used by the network service system in accordance with one embodiment of the present disclosure.

FIG. 8 is a schematic diagram of a method for performing dynamic routing of a network service system in accordance with one embodiment of the present disclosure.

FIG. 9 is a schematic diagram of a method for performing dynamic routing of a network service system in accordance with one embodiment of the present disclosure.

FIG. 10 is a flowchart of a network service method in accordance with one embodiment of the present disclosure.

FIG. 11 is a flowchart of a network service method in accordance with one embodiment of the present disclosure.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “comprises” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

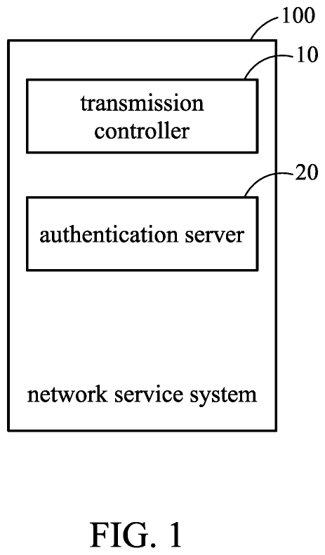

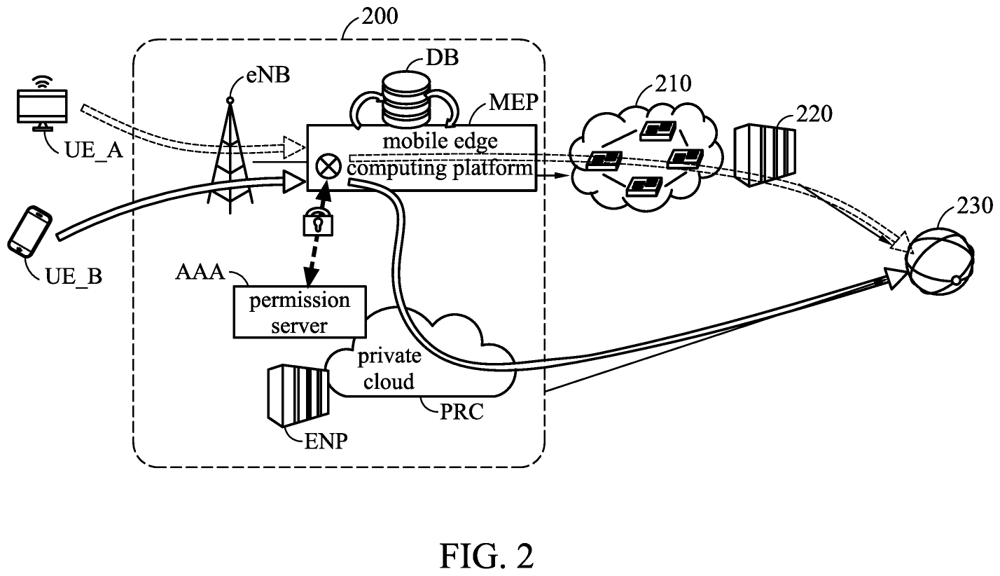

Please refer to FIGS. 1 and 2. FIG. 1 is a block diagram of a network service system 100 in accordance with one embodiment of the present disclosure. In one embodiment, the network service system 100 comprises a transmission controller 10 and an authentication server 20. The network service system 100 is suitable for use in a mobile edge computing platform (MEP). In one embodiment, the transmission controller 10 determines whether a service request belongs to a service of a proprietary network registered with the mobile edge computing platform and comprises an authentication request. The service request is from an electronic device (e.g., any kind of terminal device). The service request is, for example, a voice application (e.g., Voice over Internet Protocol application, or VoIP application), a multimedia application, or an application having another function. However, it is not limited thereto. In one embodiment, when the transmission controller 10 determines that the service request belongs to a service of the proprietary network and comprises an authentication request (for example, an application that can only be accessed by a specific proprietary network), the authentication server 20 executes an authentication mechanism according to packet information that corresponds to the service request, the authentication mechanism triggers a permission server to confirm the identity information and permission information of the electronic device. In different embodiment, the permission server can be a server that is external to or internal to the network service system 100.

Thereby, the network service system 100 can provide a service or application that corresponds to the electronic device by the mobile edge computing platform MEP according to the identity information and permission information of the electronic device. Please refer to FIG. 2, which is a schematic diagram of a network service system 100 in accordance with one embodiment of the present disclosure. In one embodiment, the part of the area 200 can be a corporate intranet, a specific service area or geographic range. In the following paragraphs, each embodiment will be described by taking an enterprise intranet as an example, but the present invention is not limited thereto. In one embodiment, the network service system 100 in FIG. 1 may be a part or the entire mobile edge computing platform MEP.

The following paragraphs provide more specifically descriptions to relevant content of the authentication mechanism.

In one embodiment, when the authentication server 20 performs the authentication mechanism, the authentication mechanism determines whether the packet information requested by the service request comprises registration information. If the authentication mechanism determines that the packet information requested by the service request comprises registration information, the registration information is transmitted to the permission server AAA. If the authentication mechanism determines that the packet information requested by the service does not comprise registration information, an authentication interface (for example, a website or an application interface) is returned to the electronic device (for example, the electronic device UE_A) through the transmission controller 10. In one embodiment, the registration information comprises an account number and a password.

In one embodiment, when the permission server AAA fails to confirm the identity information and permission information of the electronic device (for example, the electronic device UE_A), the transmission controller returns a public service from the Internet to the electronic device (for example, the electronic device UE_A) according to the service request.

For example, referring to FIG. 1 and FIG. 2, when the electronic device UE_A transmits a service request to the network service system 100 through the base station eNB, and when the transmission controller 10 determines that the service request belongs to a service of a proprietary network registered with the mobile edge computing platform and comprises an authentication request, the authentication server 20 executes an authentication mechanism according to packet information that corresponds to the service request. The authentication mechanism triggers a permission server AAA to confirm the identity information and permission information of the electronic device UE_A. After the permission server AAA confirms that the identity information of the electronic device UE_A is a general user, the permission server AAA returns the identity information and permission information of the electronic device UE_A to the mobile edge computing platform MEP. The permission server AAA returns the identity information and permission information of the electronic device UE_A to the mobile edge computing platform MEP. The mobile edge computing platform MEP sets the electronic device UE_A only can obtain a public voice application according to the identity information and permission information of the electronic device UE A. The network service system 100 searches the public voice application requested by the electronic device UE_A through backhaul network 210 and the core network 220 to the Internet 230.

In one embodiment, when the permission server AAA successfully confirms the identity information and permission information of the electronic device, the transmission controller 10 allows the electronic device (for example, the electronic device UE_B) to use the service of the proprietary network on the mobile edge computing platform MEP.

For example, in one embodiment, when the permission server AAA confirms that the identity information of the electronic device UE_B is a specific service user of the registered service. And thus, when the enterprise user of the enterprise proprietary network and/or the user called the service of the specific proprietary network, the permission server AAA returns the identity information and permission information of the electronic device UE_B to the mobile edge computing platform MEP. The mobile edge computing platform MEP sets the electronic device UE_B to directly access the enterprise version of voice application on the mobile edge computing platform MEP according to the identity information and permission information of the electronic device UE_B (for example, the enterprise version of voice application is stored in the database DB on the mobile edge computing platform MEP). The enterprise version of voice application may have specific functionality for enterprise than the public voice application on the network. In addition, by directly accessing the voice application on the mobile edge computing platform MEP, the service latency of searching for the service on the internet 230 after the core network 220 can be reduced, and the backhaul network traffic can also be reduced.

For example, in one embodiment, the permission server AAA can be regarded as the authentication, authorization, and accounting server in the enterprise ENP, and the collection of multiple servers in the enterprise ENP can be called as private cloud PRC.

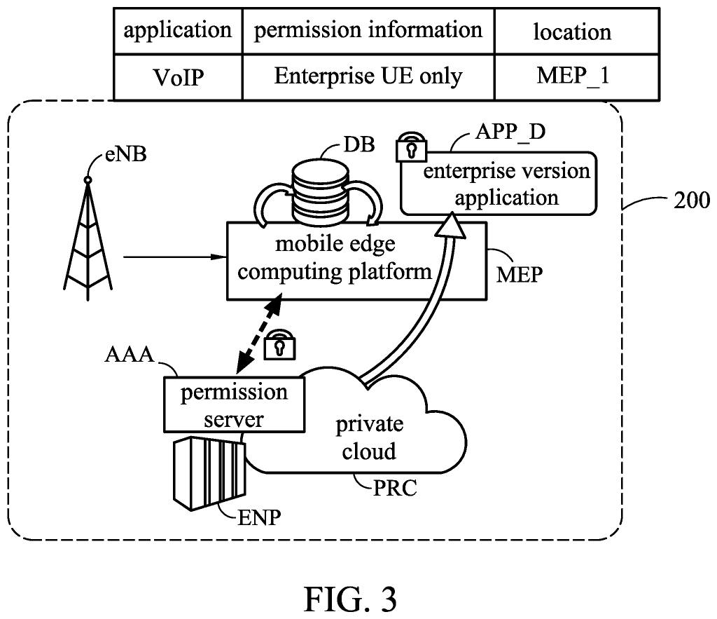

FIG. 3 is a schematic diagram of an application uploading method of a network service system 100 in accordance with one embodiment of the present disclosure. In one embodiment, in the area 200 (for convenience of description, for example, taking an enterprise intranet for enterprise service as an example), the user can upload the related information of the enterprise version application APP_D to the mobile edge computing platform MEP through the private cloud PRC of the enterprise ENP. The related information of the enterprise version application APP_D includes an application name (for example, voice application VoIP), the permission information (for example, “Enterprise UE only” means that only enterprise users can access the application), and an access location of the permission server AAA (for example, a location where be able to access the permission server by the authentication server 20) and/or the enterprise application image file. The mobile edge computing platform MEP recodes the information. In one embodiment, the application name, the permission information, the permission server AAA access location and/or the enterprise version application image file can be transmitted to any mobile edge computing platform MEP via mobile network operators.

In one embodiment, a transmission protocol and an IP address of permission server AAA are also included when uploading the proprietary service, and the proprietary service is joined to the authentication mechanism of the mobile edge computing platform MEP.

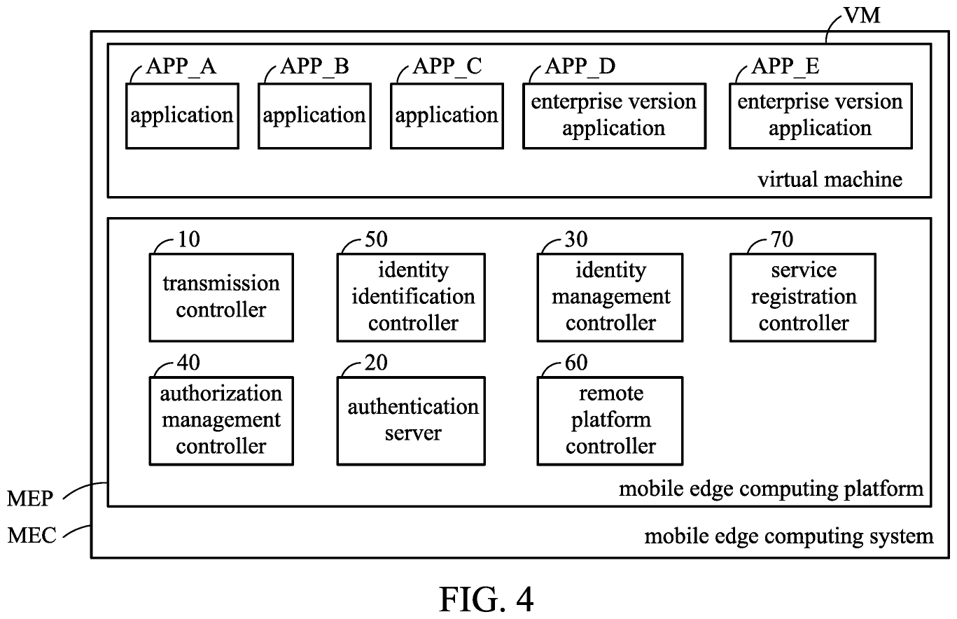

FIG. 4 is a block diagram of a mobile edge computing system MEC in accordance with one embodiment of the present disclosure. The mobile edge computing system MEC includes a set of mobile edge applications running on the virtual machine and the mobile edge computing platform MEP.

In one embodiment, the application APP_D and the application APP_E are applications for a specific service, and the application APP_D and the application APP_E can be directly accessed by an electronic device that has been approved or authenticated by a specific service. For convenience of description, for example, an enterprise service of an enterprise proprietary network is used as an example. In one embodiment, when the permission server (such as the permission server AAA shown in FIG. 3) successfully confirms that the identity information of the electronic device is an enterprise user (in other words, the enterprise user of the enterprise proprietary network), the transmission controller 10 returns a proprietary application IP address of the enterprise proprietary network service to the electronic device. When the permission server AAA successfully confirms that the identity information of the electronic device is not an enterprise user, the transmission controller 10 determines whether the Internet includes a public service having the same function as the service of the proprietary network. If the transmission controller 10 determines that the Internet includes the public service having the same function as the service of the proprietary network, the transmission controller 10 transmits the public IP to the electronic device. If the transmission controller 10 determines that the Internet does not include the public service having the same function as the service of the proprietary network, the transmission controller 10 transmits a search failure message to the electronic device.

In one embodiment, the mobile edge computing platform MEP includes a transmission controller 10, an authentication server 20, an identity management controller 30, an authorization management controller 40, an identity identification controller 50, a remote platform controller 60 and a service registration controller 70 can be individual devices, all combined devices or partially combined devices and can be implemented by using an integrated circuit, such as a microcontroller, a microprocessor, a digital signal processor, an application specific integrated circuit (ASIC), or a logic circuit. However, it is not limited thereto.

In one embodiment, when the permission server AAA successfully confirms the identity information and permission information of the electronic device, the identity management controller 30 establishes a correspondence of the identity information between an internal IP address and an external IP address. Due to the same packet information may corresponding to different IP addresses in the enterprise intranet (for example, the internal IP is used to transmit the packet information to the edge computing server inside of the enterprise) and in the external network (for example, the external IP address is used to transmit the packet information to a certain node in the Internet), it needs the identity management controller 30 to establish a correspondence of the identity information between an internal IP address and an external IP address.

In one embodiment, when the permission server AAA successfully confirms the identity information and permission information of the electronic device, the authorization management controller 40 generates a routing rule according to the external IP address, the identity information, and the authority information. The authorization management controller 40 transmits the routing rule to the identity identification controller 30 to add registration information, and the authorization management controller 40 transmits the routing rule to the transmission controller 10 to control the transmission path of the packet information.

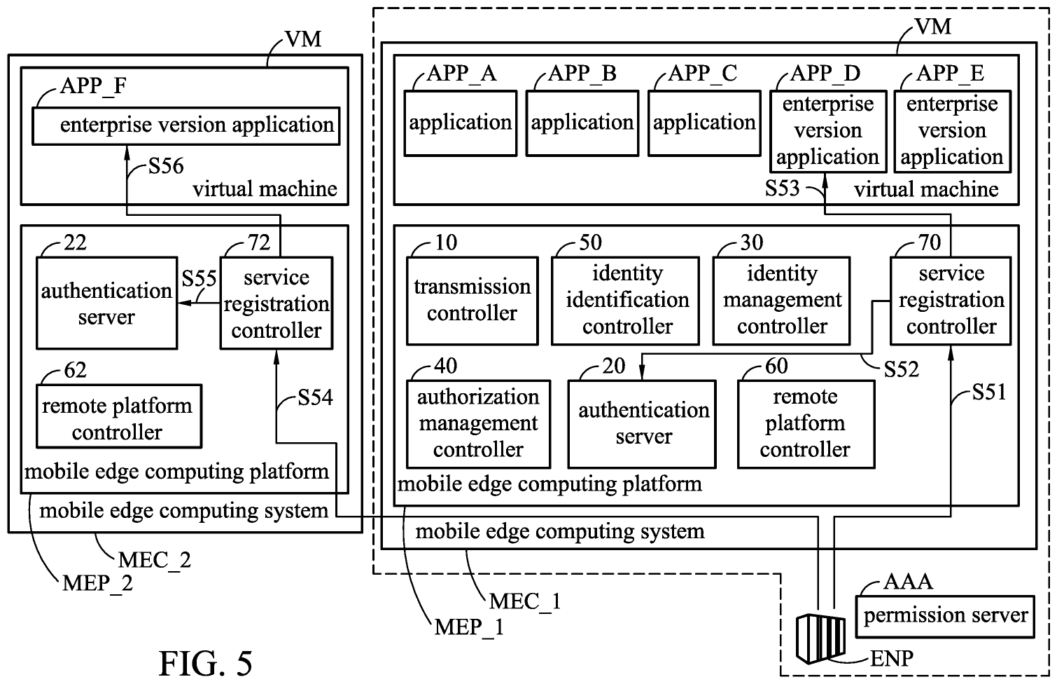

Refer to FIG. 5, which is a schematic diagram of an uploading application method used by the network service system 100 in accordance with one embodiment of the present disclosure. The following paragraphs describe the method of uploading application services on multiple mobile edge computing platforms MEP_1 and MEP_2. In one embodiment, the mobile edge computing platforms MEP_1 can be connected to the permission server AAA, and the mobile edge computing platform MEP_2 cannot be connected directly to the permission server AAA. In the embodiment of FIG. 5, the block framed by the dotted line represents an enterprise-specific network environment. The mobile edge computing system MEC_1 can directly access the authorization server AAA in the proprietary network environment. The mobile edge computing system MEC_2 is located in a different place, and the mobile edge computing system MEC_2 cannot connect to the permission server AAA.

In one embodiment, when the enterprise sends uploading information in the application service uploading request to the service registration controller 70 of the mobile edge computing platform MEP_1, the service registration controller 70 records the uploading information. The uploading information includes an application image file, an application domain name, an authentication protocol, and an access location of the permission server AAA (e.g. the location where be able to access the permission server). The authentication protocol includes an IP address of the permission server.

In one embodiment, the behavior of the uploading application service is not limited to the private network. Broadly speaking, anyone, any location can upload the uploading application service. In general, it should be carried out by mobile network operators. The uploading application services are divided into two types. In general, a public available service that does not need to identify the permissions of an electronic device (e.g., electronic device UE_A). The other is a special proprietary application service, which requires the identity authentication of the electronic device (e.g., the electronic device UE_A). Therefore, it needs to provide an authentication method to perform the identity authentication. When the proprietary application service is uploading, the invention provides the authentication method, so that the authentication server of the mobile edge computing platform (for example, the mobile edge computing platform MEP_1) can perform the authentication process with the enterprise ENP.

As shown in FIG. 5, in one embodiment, the enterprise ENP transmits an uploading request of proprietary application service APP_D to the service registration controller 70 of the local mobile edge computing platform MEP_1 (step S51). The enterprise ENP needs to transmit the content of an application image file, an application domain name, an authentication protocol, and an address for storing an application. After the service registration controller 70 records the uploading information (i.e., the application image file, the application domain name, the authentication protocol, and an access location of the permission server) of the proprietary application service APP_D, the service registration controller 70 transmits the uploading information to the authentication server 20 (step S52) to complete uploading the proprietary application service from the enterprise ENP to the local mobile edge computing platform MEP_1 (step S53).

In one embodiment, when the enterprise transmits an application service uploading request and transmits one of the uploading information in application service uploading request to the service registration controller 70 of the mobile edge computing platform MEP_1 and another service registration controller 72 of an another mobile edge computing platform MEP_2, the service registration controller 70 and service registration controller 72 record the uploading information.

For example, as shown in FIG. 5, the enterprise ENP transmits a uploading request of a proprietary application service APP_F to the service registration controller 72 of the mobile edge computing platform MEP_2 (step S54), and the enterprise ENP needs to transmit the application image file, the application domain name, the authentication protocol, and the permission access location. The service registration controller 72 transmits the uploading information to the authentication server 22 (step S55). The service registration controller 72 records the uploading information (i.e., the application image file, the application domain name, the authentication protocol, and the permission access location) of proprietary application service APP F. Then, the enterprise ENP completes uploading the proprietary application service from the enterprise ENP to the remote mobile edge computing platform MEP_2 (step S56).

Based on the above description, the proprietary application service can be selected by the enterprise ENP to upload to one or more mobile edge computing platforms.

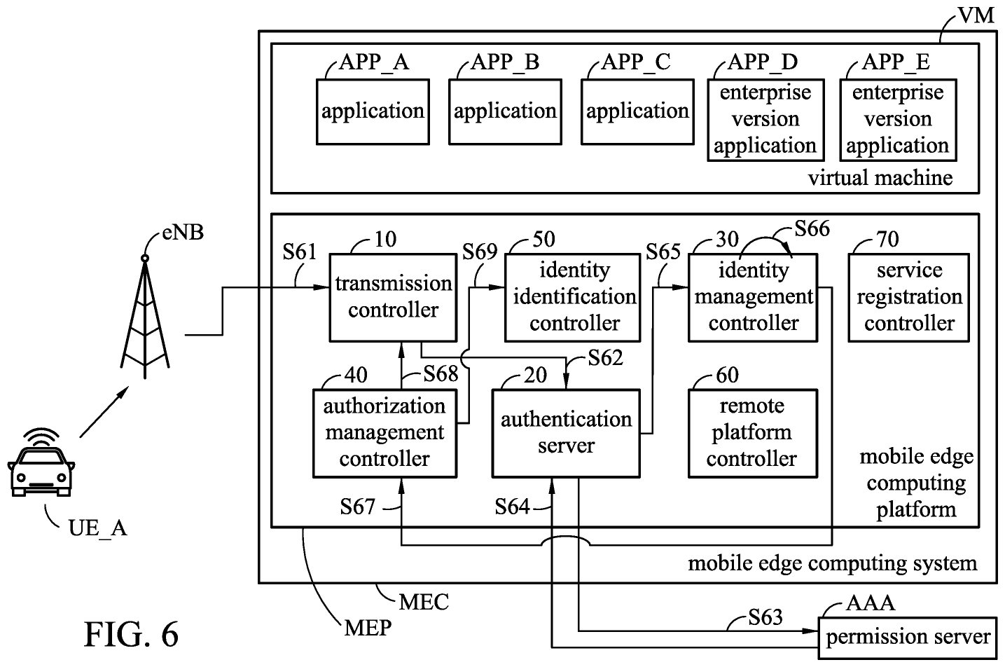

Refer to FIG. 6, which is a schematic diagram of an identity authentication method of the electronic device by the network service system 100 in accordance with one embodiment of the present disclosure. The following describes a method of authenticating the identity of an electronic device.

In one embodiment, in FIG. 6, when the electronic device UE_A on the vehicle transmits a service request to the base station eNB, the base station eNB transmits the service request to the mobile edge computing platform MEP (step S61). The transmission controller 10 detects the request service location (“Dist. IP” or “Domain name” in the packet information) in the packet information of the service request. If it is determined that the service request belongs to a service of the proprietary network and includes the authentication request, the procedure enters the authentication mechanism of the proprietary network, and the authentication server 20 executes the authentication mechanism (step S62) and determines whether the packet information includes registration information (for example, an account number and a password). If the registration information is not included, the authentication interface (for example, a webpage or an application interface) is returned to the electronic device UE_A to request the user to enter the registration information. The authentication server 20 transmits the received registration message to the permission server AAA, performs an authorization certification by executing the permission server AAA, confirms identity information and permission information of the electronic device UE_A (step S63), and the identity information and permission information of the electronic device UE_A are transmitted back to the authentication server 20 (step S64). The authentication server 20 transmits the identity information and permission information to the identity management controller 30 (step S65), and the identity management controller 30 establishes a correspondence of the identity information between an internal IP address and an external IP address (step S66). The identity management controller 30 transmits the identity information, the external IP address, and the permission information to the authorization management controller 40 (step S67). The authorization management controller 40 generates a routing rule according to the external IP address, the identity information, and the authority information, and transmits the routing rule to the transmission controller 10 (step S68). In addition, the authorization management controller 40 transmits the routing rule to the identity recognition controller 50 (step S69) to add registration information.

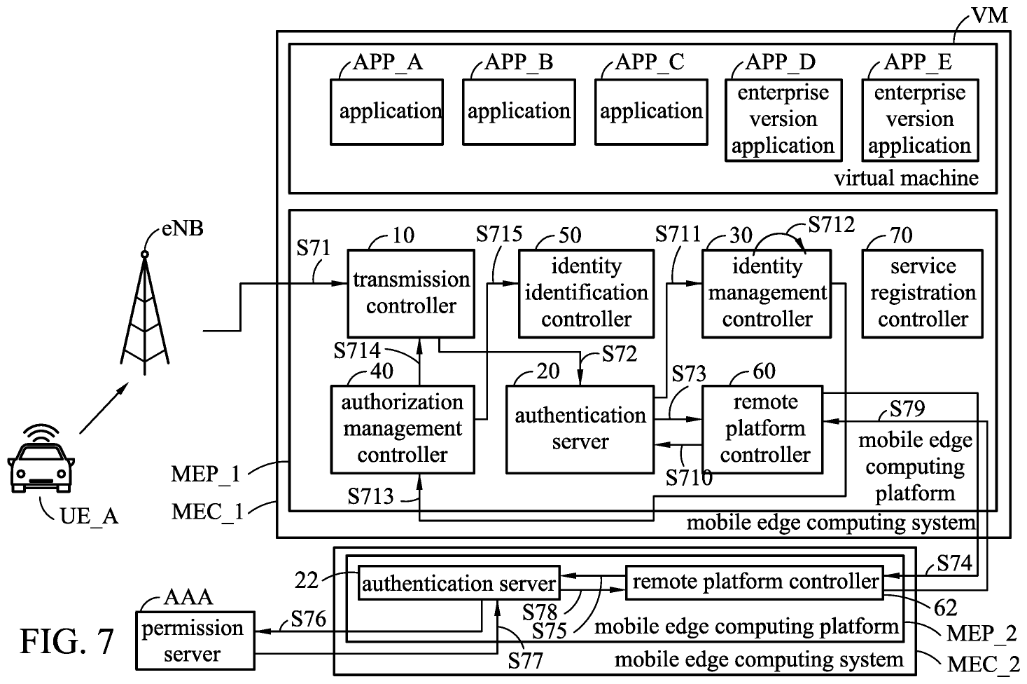

Refer to FIG. 7, which is a schematic diagram of a remote authentication method used by the network service system 100 in accordance with one embodiment of the present disclosure. The method of remote authentication is explained below. The mobile edge computing system MEC_2 of FIG. 7 is located in a proprietary network environment, while the mobile edge computing system MEC_1 is located in a different place (off-site/remotely), not in a proprietary network environment, and the electronic device UE_A requesting the service of the proprietary network is in a different place. The authentication method of the identity of the electronic device UE_A in this case is described in detail below.

In one embodiment, in FIG. 7, when the transmission controller 10 determines that the service request transmitted by the electronic device UE_A belongs to a service of the proprietary network and includes the authentication request (step S71), the authentication server 20 executes an authentication mechanism (step S72). When the electronic device UE_A wants to access the service of the proprietary network APP_D, the authentication server 20 transmits the packet information (including the permission information and the permission server accessing location of the service of the proprietary network APP_D) to the remote platform controller 60 (step 73). The remote platform controller 60 transmits the packet information to the remote platform controller 62 of the second mobile edge computing platform MEP_2 according to the permission server accessing location (MEP_2) of the service of the proprietary network APP_D (step S74). The remote platform controller 62 transmits the packet information to authentication server 22 of the second mobile edge computing platform MEP_2 (step S75). The authentication server 22 transmits the packet information to the permission server AAA (step S76). The permission server AAA confirms the identity information and permission information of the electronic device UE_A, and transmits the identity information and the permission information to the authentication server 22 (step S77). The authentication server 22 transmits the identity information and the permission information back to the remote platform controller 62 (step S78). The remote platform controller 62 transmits the identity information and the permission information to the remote platform controller 60 (step S79). The remote platform controller 60 transmits the identity information and the permission information to the authentication server 20 (step S710). The authentication server 20 transmits the identity information and the permission information to the identity management controller 30 (step S711). The identity management controller 30 establishes a correspondence of the identity information between an internal IP address and an external IP address (step S712). The identity management controller 30 transmits the external IP address, the identity information, and the permission information to the authorization management controller 40. The authorization management controller 40 generates a routing rule according to the external IP address, the identity information, and the authority information. The authorization management controller 40 transmits the routing rule to the transmission controller 10 (step S714) to control the transmission path of the packet information. In addition, the authorization management controller 40 transmits the routing rule to the identity recognition controller 50 (step S715) to make the mobile edge computing platform MEP_1 finish the remote authentication.

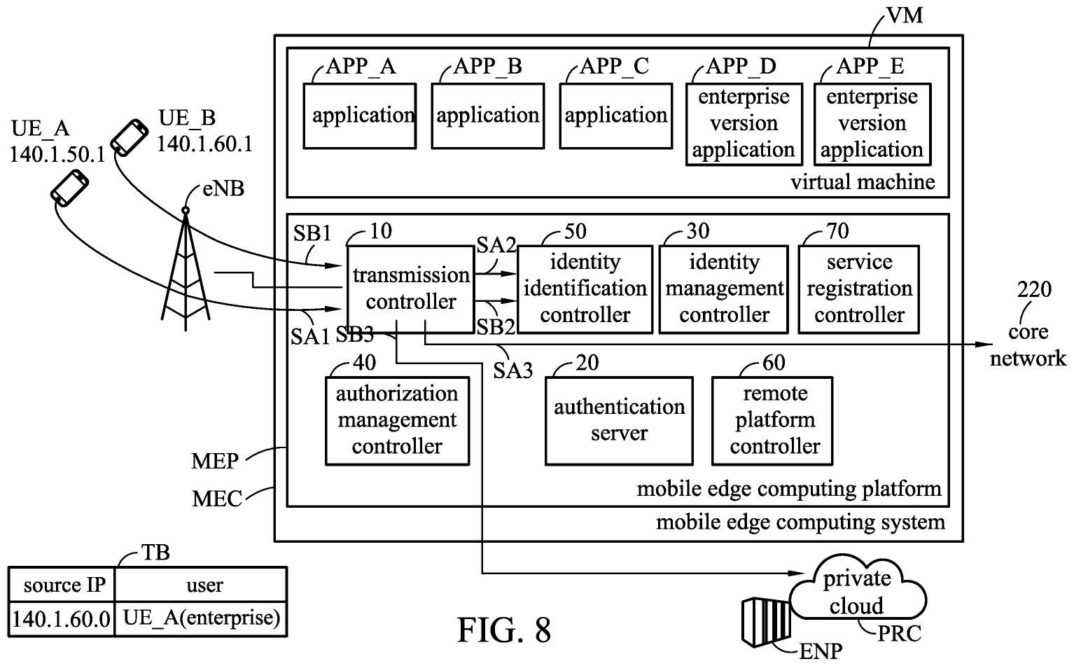

Referring to FIG. 8, FIG. 8 is a schematic diagram of a method for performing dynamic routing of a network service system 100 in accordance with one embodiment of the present disclosure. The following paragraphs describe how to perform dynamic routing method.

In one embodiment (for convenience, an enterprise service of an enterprise proprietary network is used as an example), in FIG. 8, the electronic device UE_A sends an internet request to the base station eNB (step SA1). The transmission controller 10 identifies the packet information of the electronic device UE_A (for example, searching the data of a record table TB to determine that the packet source IP: 140.1.50.1 is not in the record table TB), and confirms that the identity of the electronic device UE_A is not the enterprise user (step SA2). Therefore, the transmission controller 10 routes the packet information to the core network (step SA3). In one embodiment, the electronic device UE_B sends an internet request to the base station eNB (step SB1), and the transmission controller 10 identifies the packet information of the electronic device UE_B (for example, searching the data of the record table TB) to determine the packet source IP: 140.1.60.1 in the record table TB). It is confirmed that the identity of the electronic device UE_B is an enterprise user (step SB2). Therefore, the transmission controller 10 routes the packet information to the internal network (step SB3), for example, a private cloud PRC.

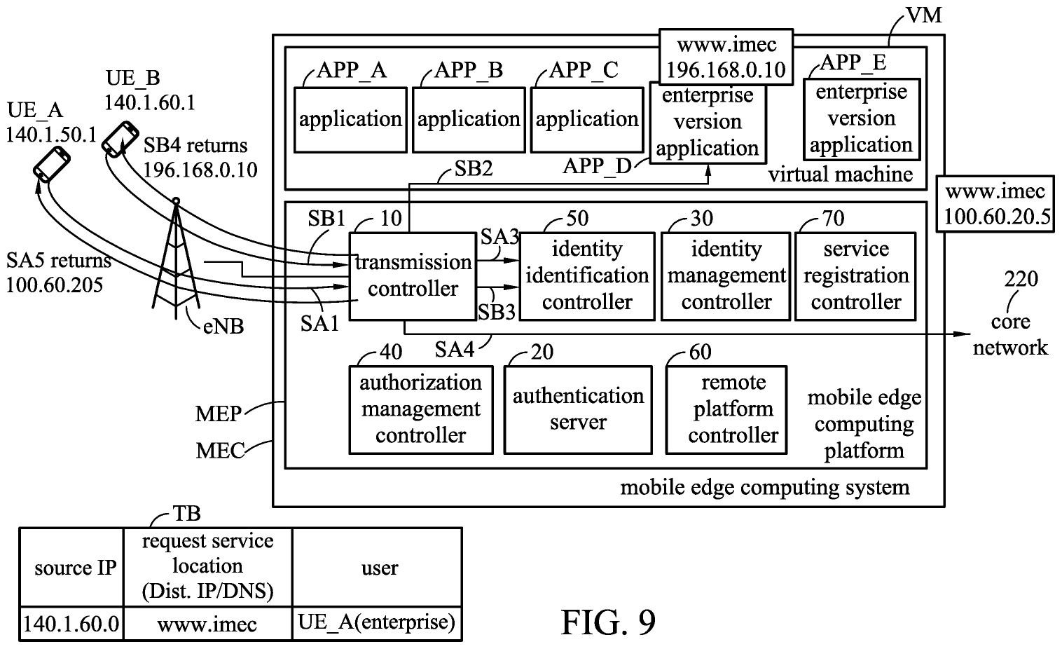

Referring to FIG. 9, FIG. 9 is a schematic diagram of a method for performing dynamic routing of a network service system 100 in accordance with one embodiment of the present disclosure. The following paragraphs describe how to perform dynamic routing method.

In one embodiment (for convenience of description, for example, an enterprise service of an enterprise proprietary network is used as an example), in FIG. 9, the electronic device UE_A sends a service request to the base station eNB (step SA1). The service request is a service of the proprietary network and includes an authentication request (for example, the request service location is “www.imec”). The transmission controller 10 recognizes the packet information of the electronic device UE_A and determines whether the service of the “www.imec” exists in the edge computing platform MEP and the electronic device UE_A having an enterprise identity (for example, searching the record table TB, and determining the source IP of the packet: 140.1.50.1 is not in the record table TB). In this example, the transmission controller 10 confirms that the identity of the electronic device UE_A is not an enterprise user (step SA3). Therefore, the transmission controller 10 routes the packet information to the core network (step SA4), connects the network to the Internet through the core network, finds the public service in the Internet, and returns the IP of the service: 100.60.20.5 (step SA5). If the public service is not found, a search failure message is returned to the electronic device UE_A.

In one embodiment, in FIG. 9, the electronic device UE_B sends a service request to the base station eNB (step SB1). The service request is a service of the proprietary network and includes an authentication request (for example, the request service location is “www.imec”), the transmission controller 10 recognizes the packet information of the electronic device UE_B, and determines whether the service of the “www.imec” exists. The mobile edge computing platform MEP and the electronic device UE_B have an enterprise identity (for example, searching the record table TB, and determining the packet source IP: 140.1.60.1 in the record table TB). In this example, the transmission controller 10 confirms that the service of “www.imec” exists in the mobile edge computing platform MEP (step SB2), its IP address is 196.168.0.10, and the identity of the electronic device UE_B is the enterprise user (step SB3). Therefore, the transmission controller 10 returns the IP of the service: 196.198.0.10 (step SB4) to make the electronic device UE_B can directly obtain the service of the proprietary network by the mobile edge computing platform MEP.

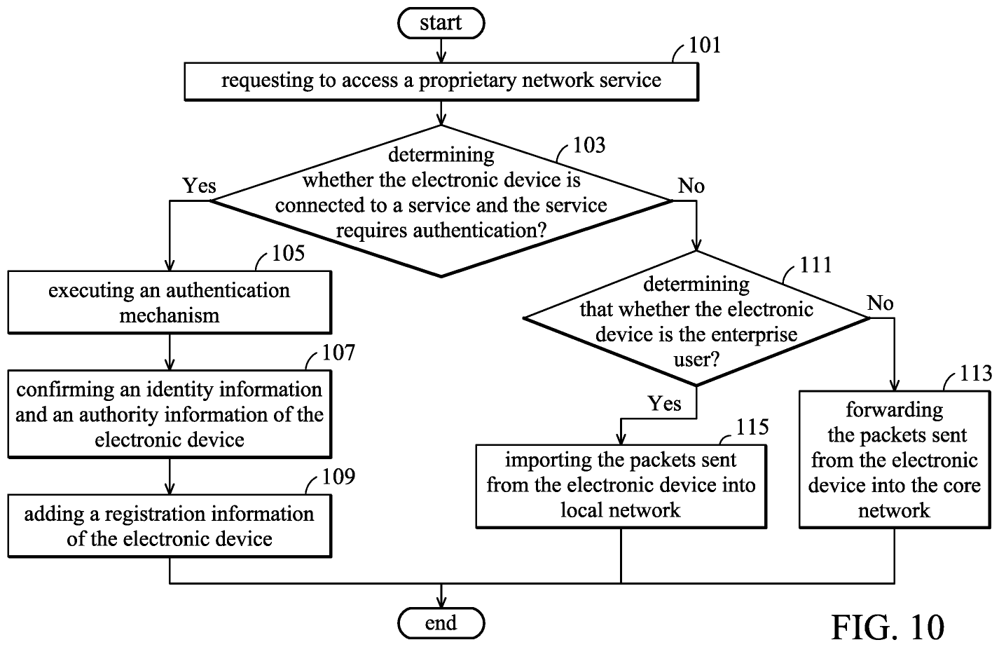

Please refer to FIG. 10, which uses an enterprise service of an enterprise proprietary network as an example. FIG. 10 is a flowchart of a network service method in accordance with one embodiment of the present disclosure. Since the detailed technical content in this example has been described in detail in the other paragraphs above, the details are not described again.

In step 101, an electronic device requests to access a proprietary network service. In one embodiment, the proprietary network service can be any application service including general online behavior, not limited to application services.

In step 103, a mobile edge computing platform determines whether the electronic device is connected to a service and the service requires authentication. If so, step 105 is performed. If not, step 111 is performed.

In step 105, the mobile edge computing platform performs an authentication mechanism.

In step 107, a permission server confirms identity information and permission information of the electronic device.

In step 109, the mobile edge computing platform adds registration information of the electronic device.

For convenience, the enterprise network service of an enterprise proprietary network is used as an example. In step 111, the mobile edge computing platform determines whether the electronic device is an enterprise user (which has a permission to access the enterprise network service). If so, step 150 is performed. If not, step 113 is performed.

In step 113, the mobile edge computing platform forwards the packets sent from the electronic device into the core network.

In step 115, the mobile edge computing platform imports the packets sent from the electronic device into local network (e.g., private cloud).

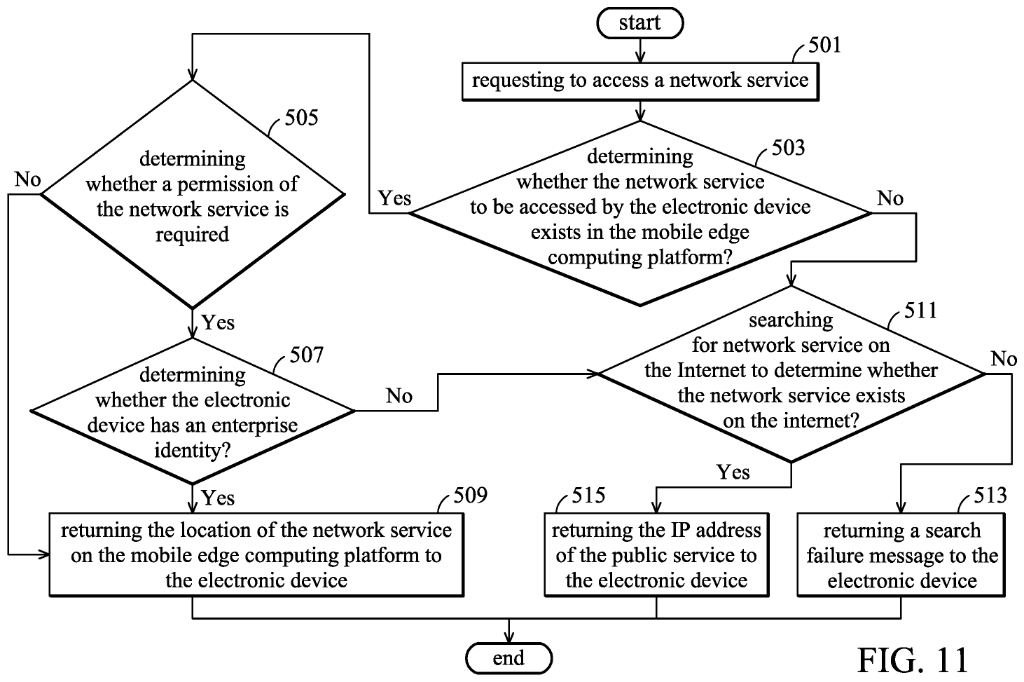

Please refer to FIG. 11, which is a flowchart of a network service method in accordance with one embodiment of the present disclosure and which uses an enterprise service of an enterprise proprietary network as an example. Since the detailed technical content in this example has been described in detail in the other paragraphs above, the details are not described again.

In step 501, an electronic device requests to access a network service.

In step 503, a mobile edge computing platform determines whether the network service to be accessed by the electronic device exists in the mobile edge computing platform.

In step 505, the mobile edge computing platform determines whether a permission to access the network service is required. If so, step 507 is performed. If not, step 509 is performed.

In step 507, the mobile edge computing platform determines whether the electronic device has an enterprise identity. If so, step 509 is performed. If not, step 511 is performed.

In step 509, the mobile edge computing platform returns the location of the network service on the mobile edge computing platform to the electronic device.

In step 511, the mobile edge computing platform searches for network service on the Internet to determine whether the network service exists on the internet. If so, step 515 is performed. If not, step 513 is performed.

In step 513, the mobile edge computing platform returns a search failure message to the electronic device.

In step 515, the mobile edge computing platform returns the IP address of the public service to the electronic device.

In the network service system and the network service method described above, when the permission server confirms that the identity information of the electronic device is a user of a service of a proprietary network, the permission server identifies the identity of the electronic device. The identity information and permission information of the electronic device are passed back to the mobile edge computing platform. The mobile edge computing platform sets the electronic device to directly access the proprietary network version application on the mobile edge computing platform according to the identity information and permission information of the electronic device. By directly accessing the proprietary network version application on the mobile edge computing platform without passing the core network, the latency of the internet search can be reduced, and the network bandwidth needed by the switch and router can be reduced.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

1. A network service system, suitable for use in a mobile edge computing platform, the network service system comprising:
a transmission controller, configured to determine whether a service request belongs to a service of a proprietary network registered with the mobile edge computing platform and comprises an authentication request, wherein the service request is from an electronic device; and
an authentication server, wherein when the transmission controller determines that the service request belongs to the service of the proprietary network and comprises the authentication request, the authentication server executing an authentication mechanism according to a packet information that corresponds to the service request, the authentication mechanism triggers a permission server to confirm and return an identity information and a permission information of the electronic device.

2. The network service system of claim 1, further comprising:
an identity management controller, wherein when the permission server successfully confirms the identity information and the permission information of the electronic device, the identity management controller establishes a correspondence of the identity information between an internal IP address and an external IP address; and
an authorization management controller, wherein when the permission server successfully confirms the identity information and the permission information of the electronic device, the authorization management controller generates a routing rule according to the external IP address, the identity information, and the authority information, the authorization management controller transmits the routing rule to the transmission controller to control a transmission path of the packet information, and the authorization management controller transmits the routing rule to an identity identification controller to add registration information.

3. The network service system of claim 1, wherein when the authentication server performs the authentication mechanism, the authentication mechanism determines whether the packet information requested by the service request comprises registration information;
if the authentication mechanism determines that the packet information requested by the service request comprises the registration information, the registration information is transmitted to the permission server; and
if the authentication mechanism determines that the packet information requested by the service does not comprise the registration information, an authentication interface is returned to the electronic device through the transmission controller.

4. The network service system of claim 3, wherein the registration information comprises an account number and a password.

5. The network service system of claim 1, wherein when the permission server successfully confirms the identity information and the permission information of the electronic device, the transmission controller allows the electronic device to use the service of the proprietary network on the mobile edge computing platform.

6. The network service system of claim 1, wherein when the permission server fails to confirm the identity information and the permission information of the electronic device, the transmission controller returns a public service from an Internet to the electronic device according to the service request.

7. The network service system of claim 1, further comprising:
a remote platform controller,
wherein when the service request transmitted by the electronic device belongs to the service of the proprietary network and comprises the authentication request and the electronic device is located in a different place from the mobile edge computing platform storing the service of the proprietary network, the remote platform controller transmits the packet information to an another remote platform controller in an another mobile edge computing platform;
the another remote platform controller transmits the packet information to another authentication server of the another mobile edge computing platform;
the another authentication server transmits the packet information to the permission server;
the permission server confirms the identity information and the permission information of the electronic device;
the another authentication server transmits the identity information and the permission information to the another remote platform controller; and
the another remote platform controller transmits the identity information and the permission information back to the remote platform controller.

8. The network service system of claim 1, further comprising:
a service registration controller,
wherein when the mobile edge computing platform receives an application service uploading request and transmits an uploading information in the application service uploading request to the service registration controller of the mobile edge computing platform, the service registration controller records the uploading information ,
wherein the uploading information comprises an application image file, an application domain name, an authentication protocol, and an access location of the permission server, and
wherein the authentication protocol comprises an IP address of the permission server.

9. The network service system of claim 1, further comprising:
a service registration controller,
wherein when the mobile edge computing platform receives an application service uploading request and transmits an uploading information in the application service uploading request to the service registration controller of the mobile edge computing platform and an another service registration controller of an another mobile edge computing platform, the service registration controller and the another service registration controller record the uploading information.

10. The network service system of claim 1, wherein when the permission server successfully confirms that the identity information of the electronic device has a permission to access the proprietary network, the transmission controller returns a proprietary application IP address of the service of the proprietary network to the electronic device, and
wherein when the permission server successfully confirms that the identity information of the electronic device does not have the permission to access the proprietary network, the transmission controller determines whether an Internet comprises a public service having the same function as the service of the proprietary network,
if the transmission controller determines that the Internet comprises the public service having the same function as the service of the proprietary network, the transmission controller transmits the public service to the electronic device, and
if the transmission controller determines that the Internet does not comprise the public service having the same function as the service of the proprietary network, the transmission controller transmits a search failure message to the electronic device.

11. A network service method, suitable for use in a mobile edge computing platform, the network service method comprising:
determining whether a service request belongs to a service of a proprietary network registered with the mobile edge computing platform and comprises an authentication request, wherein the service request is from an electronic device; and
when determining that the service request belongs to the service of the proprietary network and comprises the authentication request, executing an authentication mechanism according to a packet information that corresponds to the service request, and the authentication mechanism triggers a permission server to confirm and return an identity information and a permission information of the electronic device.

12. The network service method of claim 11, further comprising:
when successfully confirming the identity information and permission information of the electronic device, establishing a correspondence of the identity information between an internal IP address and an external IP address, generating a routing rule according to the external IP address, the identity information, and the permission information, and adding a registration information.

13. The network service method of claim 11, wherein when performing the authentication mechanism, the authentication mechanism determines whether the packet information requested by the service request comprises a registration information;
if the authentication mechanism determines that the packet information requested by the service request comprises the registration information, the registration information is transmitted to the permission server; and
if the authentication mechanism determines that the packet information requested by the service does not comprise the registration information, an authentication interface is returned to the electronic device.

14. The network service method of claim 13, wherein the registration information comprises an account number and a password.

15. The network service method of claim 11, wherein when the permission server successfully confirms the identity information and the permission information of the electronic device, the network service method further comprising:
allowing the electronic device to use the service of the proprietary network on the mobile edge computing platform.

16. The network service method of claim 11, wherein when the permission server fails to confirm the identity information and the permission information of the electronic device, the network service method further comprises:
returning a public service from an Internet to the electronic device according to the service request.

17. The network service method of claim 11, wherein when the service request transmitted by the electronic device belongs to the service of the proprietary network and comprises the authentication request, and the electronic device is located in a different place from the mobile edge computing platform storing the service of the proprietary network, the network service method further comprises:
transmitting the packet information to an another mobile edge computing platform, and the another mobile edge computing platform forwards the packet information to the permission server, the permission server confirms the identity information and the permission information of the electronic device and transmits the identity information and the permission information to the another mobile edge computing platform, and the another mobile edge computing platform transmits the identity information and the permission information back to the mobile edge computing platform.

18. The network service method of claim 11, wherein when the mobile edge computing platform receives an application service uploading request and transmits an uploading information in the application service uploading request to the mobile edge computing platform, the mobile edge computing platform records the uploading information;
wherein the uploading information comprises an application image file, an application domain name, an authentication protocol, and an access location of the permission server; and
wherein the authentication protocol comprises an IP address of the permission server.

19. The network service method of claim 11, wherein when the mobile edge computing platform receives an application service uploading request and transmits an uploading information in the application service uploading request to the mobile edge computing platform and an another mobile edge computing platform, the mobile edge computing platform and the another mobile edge computing platform record the uploading information.

20. The network service method of claim 11, wherein when the permission server successfully confirms that the identity information of the electronic device has a permission to access the proprietary network, the network service method further comprises:
returning a proprietary application IP address of the service of the proprietary network to the electronic device; and
when the permission server successfully confirms that the identity information of the electronic device does not have the permission to access the proprietary network, the network service method further comprises:
determining whether an Internet comprises a public service having the same function as the service of the proprietary network;
upon determining that the Internet comprises the public service having the same function as the service of the proprietary network, transmitting the public service to the electronic device; and
upon determining that the Internet does not comprise the public service having the same function as the service of the proprietary network, transmitting a search failure message to the electronic device.
